(19) United States
(12) Patent Application Publication
(10) Pub. No.: US 2020/0122542 A1
(43) Pub. Date: Apr. 23, 2020

(54) SYSTEM FOR DETECTING MACHINE ELEVATION OF A COLD PLANER

(71) Applicant: Caterpillar Paving Products Inc., Brooklyn Park, MN (US)

(72) Inventors: Eric S. Engelmann, Delano, MN (US); Conwell K. Rife, JR., Wayzata, MN (US)

(73) Assignee: Caterpillar Paving Products Inc., Brooklyn Park, MN (US)

(21) Appl. No.: 16/659,084

(22) Filed: Oct. 21, 2019

Related U.S. Application Data
(60) Provisional application No. 62/749,575, filed on Oct. 23, 2018.

(51) Int. Cl. B60G 17/019; E01C 23/06; B60G 17/0165; B60G 3/01

(52) U.S. Cl. CPC B60G 17/01908; E01C 23/06; B60G 17/0165; B60G 3/01; B60G 2400/0513; B60G 2400/82; B60G 2400/0511; B60G 2400/0512; B60G 2300/09

(57) ABSTRACT

A machine for processing a road construction material includes two or more extendable support units, where each of the two or more extendable support units have a first segment coupled to the frame and a second segment configured to contact a surface to support the frame. The machine also includes an orientation sensor that is configured to measure an orientation of the frame. The machine further includes a distance sensor that configured to measure a distance from the frame to the surface. The machine additionally includes a controller configured to determine, based on the orientation and the distance, a position of at least one extendable support unit of the two or more extendable support units.

### CLAIM OF PRIORITY

This application claims the benefit of priority to U.S. Provisional Application Ser. No. 62/749,575, filed on Oct. 23, 2018, which is incorporated herein by reference in its entirety.

### TECHNICAL FIELD

The present application relates generally, but not by way of limitation, to control systems for construction machines. More particularly, the present application relates to control systems used to determine an elevation of a construction machine having a frame supported by two or more extendable support units.

### BACKGROUND

Cold planar machines include a class of construction machines that are configured to process paving material, such as by scarifying, removing, or reclaiming such material from the surface of a paved road. These machines can include a frame having a rotary cutting tool for processing the paving material, and two or more tracks or wheel units for propelling the cold planar machine forward. The two or more tracks or wheel units can be coupled to the frame of the cold planer using extendable struts that can be adjusted (e.g., extended or retracted) to raise or lower the frame of the cold planer, such as to control the depth at which the cold planer cuts into a surface or road.

U.S. Pat. No. 9,656,530B2 to Busley et al., entitled “Automotive construction machine, as well as lifting column for a construction machine” discusses “an automotive road construction machine, particularly a recycler or a cold stripping machine, comprising an engine frame that is supported by a chassis, a working roller which is stationarily or pivotally mounted on the engine frame and is used for machining a ground surface or road surface. The chassis is provided with wheels or tracked running gears which are connected to the engine frame via lifting column and are vertically adjustable relative to the engine frame. Each individually vertically adjustable lifting column is equipped with a device for measuring the actual vertical state of the lifting column.”

### BRIEF DESCRIPTION OF THE DRAWINGS

FIG. 1 is a perspective view of a machine for processing paving material, according to various embodiments.

FIG. 2 is a diagrammatic top view of a machine for processing paving material, according to various embodiments.

FIG. 3 illustrates a process for determining the elevation of a machine for processing paving material, according to various embodiments.

### DETAILED DESCRIPTION

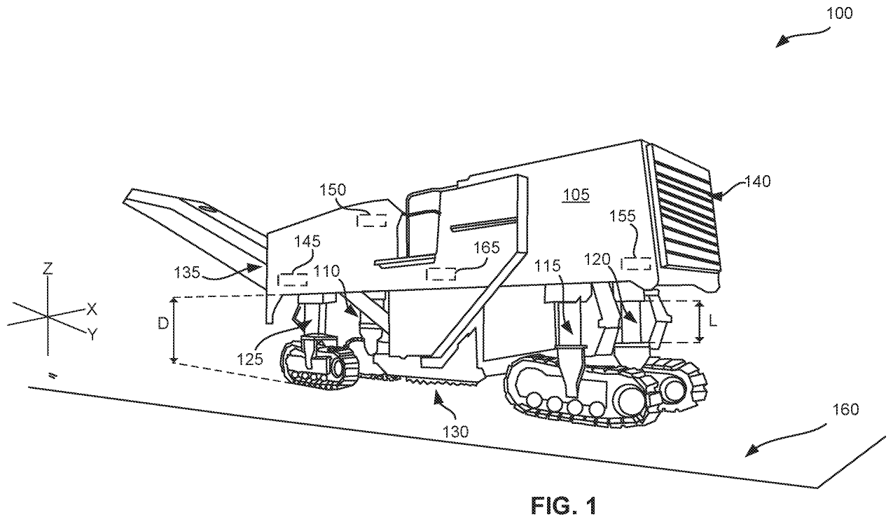

FIG. 1 is a perspective view of a machine 100 for processing paving material, according to various embodiments. The machine 100 can include a cold planer machine configured to process, such as by performing one or more milling operations, road paving material by scarifying, removing, mixing, or reclaiming such paving material from a paved surface, such as the surface 160. The machine 100 can also include a rotary mixer machine configured to process paving material to improve a surface, such as by milling paving material reclaimed from the surface, mixing the reclaimed paving material with a base material, and depositing the mixture over the surface. The machine 100 can include a system for determining the elevation of the machine relative to the surface 160, as described below.

The machine 100 can include a frame 105 and extendable support units 110, 115, 120, and 125. The machine 100 can also include a distance sensor 145, a controller 150, and an orientation sensor 165. In some embodiments, the machine 100 can include one or more additional distance sensors 155.

The frame 105 can include a front end 135 (e.g., an anterior end), a back end 140 (e.g. posterior end), and a material processing unit 130, such as a milling assembly, disposed between the front end and the back end. The material processing unit 130 can be fixedly coupled to the frame 105, such as to cause the elevation of the frame to determine the depth to which the material processing unit engages the surface 160 during operation of the machine 100. Accordingly, increasing or decreasing the elevation of the frame 105 can increase or decrease the dept to which the material processing unit 130 cuts into the surface 160. In some embodiments, the material processing unit 130 can be coupled to the frame 100 at, or near, the center of mass of the machine 100.

Extendable support units 110, 115, 120, and 125 can be coupled to the frame 105, such as to provide support (e.g., vertical support in the direction of the Z axis) for the frame 105 on the surface 160. In some embodiments, each of the extendable support units can have a first region (or area) coupled to the frame 105 and a second region configured to engage the surface 160. The first region and the second region can be adjustably coupled together by a hydraulic cylinder. The position of each hydraulic cylinder can be independently adjusted to extend or contract each extendable support unit, such as to vertically increase or decrease the length L of each extendable support unit in the direction of the vertical Z-axis. The position of the hydraulic cylinders (e.g., the position of the extendable control units) can be adjusted manually by an operator of the machine 100, or automatically by the controller 150. The position of the hydraulic cylinders can also be adjusted, or changed, due to a change in the topology of the surface 160 under the extendable support units 110, 115, 120, and 125. Such change in the topology of the surface 160 can include a depression, cut, or hole, in the surface 160. The position of the hydraulic cylinders can be controllably adjusted to lift or lower the frame 105 relative to the surface 160. In some embodiments, the position of the hydraulic cylinders can be adjusted to limit the displacement of the frame 105, such as when there is a sudden or unexpected change in the topology the surface 160 during operation of the machine 10X). The relative positions of the hydraulic cylinders associated with the extendable support member 110, 115, 120, and 125, can determine, or indicate, an orientation the frame 105.

The distance sensor 145 can be coupled to the frame 105 and configured to measure a distance D between the frame 105 and the surface 160. In some embodiments, the distance sensor 145 can be configured to measure other distances relative to the frame 105, such as a distance between the frame and an area on the second region of an extendable support unit. The distance sensor 145 can be any optical, electrical, or electromechanical, device configured to measure distance to a surface. In some embodiments, the distance sensor 145 can be an optical sensor and configuring the sensor to measure a distance between the frame 105 and the surface 160 can include coupling the sensor to an area of frame to enable an optical signal transmitted by the sensor to have an unobstructed round-trip path between the frame and the surface 160. In some embodiments, the distance sensor 145 can be a sonic sensor and configuring the sensor to measure a distance between the frame 105 and the surface 160 can include coupling the sensor to an area of frame to enable a sonic signal transmitted by the sensor to impact the surface 160 at an indicated angle between the travel path of the sensor and a plane formed by the surface 160. In some embodiments, the distance sensor 145 can be coupled to the frame 105 proximate to the back end 140. In operation, the distance sensor 145 can generate a data, such as a modulated electrical signal, that is indicative of a distance between the frame 105 and the surface 160.

An orientation sensor 165 can be coupled to the frame 105, such as to determine, or to generate data indicative of, an orientation of the frame. In some embodiments, the orientation sensor 165 can include an inertial sensor or inertial measurement unit, such as a sensor have up to 6 degrees of freedom, such as to measure a pitch, roll, yaw, surge, heave, or sway of the frame 105. Such sensors can be configured to measure inclination, and angular speed or acceleration, relative to, three spatial axes, such as to measure the orientation of the frame relative to the center of mass of the earth. Accordingly, the orientation sensor 165 can be coupled to the frame 105 proximate to the center of mass of the machine 100.

In some embodiments, the orientation sensor 165 can include a set of three or more distance sensors, such as the distance sensor 145 and two or more additional distance sensors 155. Distance measurements generated by these three or more distance sensors can be mathematically aggregated to determine an orientation of the frame 105 relative to the surface 160. In some embodiments, the three or more sensors can be coupled to the frame 105 in a specified pattern to form a plane. An orientation of such plane, such as determined by distance measurements generated as each sensor, can be used to determine the orientation of the frame 105 relative to the surface 160.

The controller 150 can include an electronic control unit (ECU) configured, such as with computer executable code stored in a non-transitory computer-readable storage medium, to monitor the distance sensor 145 to determine a distance from the frame 105 to the surface 160. The controller 150 can also be configured to monitor the orientation sensor 165 to determine an orientation of the frame 105. Such monitoring can include receiving, from the distance sensor 145 and the orientation sensor 165, electronic data that is indicative of the measured distance or orientation, respectively. The controller 150 can use the measured orientation of the frame 105 and the distance from the frame 105 to the surface 160 to mathematically or algorithmically determine the positions of the extendable support units 110, 115, 120, or 125. The determined positions can correspond to the extension length of each of the extendable support units 110, 115, 120, or 125. The determined position can also correspond to the position of the hydraulic cylinders associated with each of the extendable support units 110, 115, 120, or 125. Determining the positions of the extendable support units 110, 115, 120, or 125 can include deriving a relative position of each of the extendable support units 110, 115, 120, or 125 based on the orientation measurement. Such relative position may indicate the position of each control unit relative to a common reference extendable support unit. Determining the position of the extendable support units 110, 115, 120, or 125 can also include deriving an absolute position of each extendable support unit, such as the position of the second region of an extendable support unit relative to the frame 105, using the measured distance data. The position of the extendable support units 110, 115, 120, and 125 can also be determined directly by simultaneously using the distance and orientation measurements

In some embodiments, the controller 150 can use information indicative of the position of the distance sensor and the position of the orientation sensor on the frame 105 to determine the position of the extendable support units 110, 115, 120, or 125. Such information, for example, can be used to mathematically weight or scale a contribution of the position of an extendable support unit to the orientation of the frame 105.

The controller 150 can also be configured to determine the elevation of the frame 105 based on the determined positions of the extendable support units 110, 115.120, or 125. Such elevation can include an elevation of the center of mass of the frame 105, such as an elevation at the material processing unit, above the surface 160.

The controller 150 can also be configured to determine or predict a change in the elevation or orientation of the frame 105 based on a recent change in a position of the extendable support units 110, 115, 120, or 125. The controller 150 can use the predicted change to controllably extend or contract one or more of the extendable support units 110, 115, 120, or 125 to prevent or limit the displacement of the frame 105 due to the predicted change in the elevation or orientation of the frame.

The controller 150 can also be configured to determine an extension or contraction rate of the extendable support units 110, 115, 120, or 125 based on the determined positions of the extendable support units 110, 115, 120, or 125. Such determining can include calculating the extension or contraction rate based the positions of the extendable control units 110, 115, 120, or 125 at two or more different times during an indicated interval of time. The controller 150 can use the determined extension or contraction rate to control the speed at which the extendable control units 110, 115, 120, or 125 are extended or contracted. The controller 150 can, for example, continuously calculate the positions of the extendable support units 110, 115, 120, or 125, while modulating the energy used to extend or contract the support units. Such energy can be adjusted based extension or contraction rates determined from the continuously calculated positions to attain a desired extension or contraction rate.

The controller 150 can be configured to adjust the extension of one or more of the extendable support units 110, 115, 120, or 125 by generating a control signal, based on the calculated position of the support unit, to actuate the hydraulic cylinder associated with the control unit.

The controller 150 can also be configured to enable, or adapt the machine 100 to perform, one or more functions of a milling process based on the calculated positions of the extendable support units 110, 115, 120, or 125.

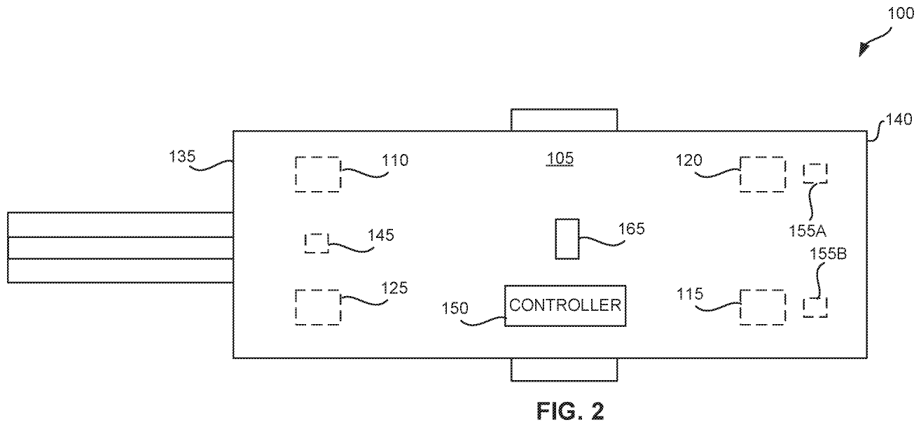

FIG. 2 is a diagrammatic top-down view of a machine 100 for processing paving material, according to various embodiments. A shown in the FIG. 2, the machine 100 can have one or more extendable support unit 110 or 125 coupled to the frame 105 proximate to the back of the frame 140, and one or more extendable support unit 115 or 120 coupled to the frame proximate to the front end 135. FIG. 2 illustrates one possible location for the distance sensor 145 and the inertial orientation sensor 165. As shown in FIG. 2, the distance sensor 145 can be located underneath the frame 105 proximate to the extendable support units 115 or 125, while the orientation sensor 156 can be located proximate to the center of mass of the machine 100. Other arrangements and other selections or quantities of sensors can be used with the techniques of the current disclosure. In some embodiments, one or more additional distance sensors 155A or 155B can be used to measure a distance from the frame 105 to the surface 160 (FIG. 1), such as to increase the accuracy of the positions of the extendable control units as determined by the controller 150. In some embodiments, the inertial orientation sensor 165 can be replaced by three or more distance sensors, such as distance sensor 145 and additional sensors 155A and 155B, as described herein. Such three or more distances sensors can be coupled to the frame 105 according an indicated pattern, such as to form a plane that is usable by the controller 150 to determine an orientation of the frame 105.

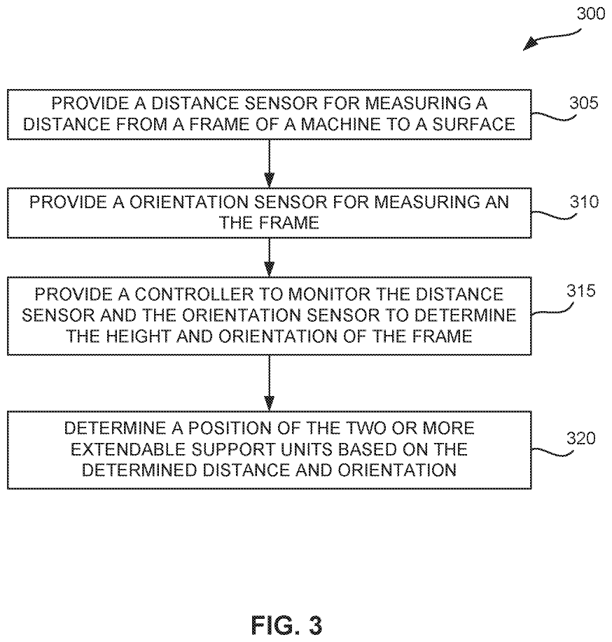

FIG. 3 illustrates a process 300 for determining the elevation of a machine for processing paving material, according to various embodiments. Such machine can be an example of the machine 100, as shown in FIG. 1 and FIG. 2. One or more steps of the process 300 can be executed by an entity, such as to provided or implement the systems, techniques, device, and operations described herein.

At 305, a distance sensor can be provided. The distance sensor can be any sensor configured to measure a distance from a frame of a machine, such as the machine 100 (FIG. 1), to a surface, such as the surface 160 (FIG. 1). Providing the distance sensor can include coupling, or providing means for coupling, the sensor to an indicated location on the frame for the machine.

At 310, an orientation sensor can be provided. Such orientation sensor can include any sensor configured to measure slope and pitch of the machine. Such sensor can include an inertial sensors, such as an inertial six degree of freedom sensor, as described herein. Alternatively, such sensor can include a set of three or more distance sensors configured to be arranged to form a plane on the frame of the machine.

At 315, a controller can be provided. The controller can be a machine ECU, as described herein. Providing the controller can include configuring a non-transitory computer readable storage medium, accessible by the controller, with a computer executable code that, when executed by a processor of the controller, causes to controller to execute operations to determine the elevation of the frame of the machine using the distance sensor and the orientation sensor. Such operations can include determining a position of two or more extendable support units coupled to the frame of the machine. Such determining can include monitoring an output of the distance sensor to determine a distance from the frame of the machine to a surface and monitoring an output of the orientation sensor to determine an orientation of the frame. Such determining can then include determining a vertical position of the two or more extendable support units based on the determined distance and orientation, as shown a 320.

The operations executable by the controller can also include adjusting the elevation of the frame of the machine based on the position of the two or more extendable support units, as described herein. Such adjusting can include adjusting an extension of the two or more extendable support units based on the determined position of the two or more extendable support units. Such adjusting can also include controlling, such as by using a closed loop control system, a rate of adjusting the extension of the two or more extendable support units, such as to minimize displacement of the frame of the machine from an initial position.

The operations executable by the controller can also include determining a position of the two or more extendable support units based a location of the distance sensor and a location of the orientation sensor on the frame.

Providing the controller can also include configuring the controller to generate one or more control signals to adjust an extension of the one or more extendable support units based on the position of the one or more extendable support units. Providing the controller can additionally include configuring the controller to generate one or more control signals to actuate one or more electrical or mechanical devices to perform the operations described herein.

The term “machine readable medium” can include any medium that is capable of storing, encoding, or carrying instructions for execution by a machine and that cause the machine to perform any one or more of the techniques of the present disclosure, or that is capable of storing, encoding or carrying data structures used by or associated with such instructions. Non-limiting machine readable medium examples can include solid-state memories, and optical and magnetic media. Specific examples of machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

Each of the non-limiting aspects or examples described herein can stand on its own or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

### INDUSTRIAL APPLICABILITY

The present disclosure describes techniques for determining the elevation of a frame of a machine, such as a cold planar. Such techniques include using a distance sensor to measure the distance from the frame of the machine to the surface of a roadway. Such techniques also include using an inertial sensor, a 6-degree of freedom sensor, or a set of distance sensors configured to from a plane, to determine an orientation of the frame of the machine. The measured distance and orientation can then be used to calculate, or to algorithmically determine, the vertical position of two or more extendable supports units configured to vertically support the machine frame on the surface of the roadway.

The techniques described herein can enable more precise control of cold planar and mixer machine milling operation, such as improve the productivity of these machines while using a minimum of new hardware.

What is claimed is:

1. A machine for processing a road construction material, the machine comprising:
a frame;
two or more extendable support units, each of the two or more extendable support units having a first segment coupled to the frame and a second segment configured to contact a surface to support the frame;
an orientation sensor configured to measure an orientation of the frame;
a distance sensor configured to measure a distance from the frame to the surface; and
a controller configured to determine, based on the orientation and the distance, a position of at least one extendable support unit of the two or more extendable support units.

2. The machine of claim 1, wherein the distance sensor is configured to measure a distance from the distance sensor to a surface coupled to the second segment of the at least one extendable support unit.

3. The machine of claim 1, wherein the controller is further configured to generate a control signal to extend one or more extendable support units of the two or more extendable support units based on the determined position.

4. The machine of claim 3, wherein the controller is further configured to generate, based on the determined position, a control signal to control a rate at which the one or more extendable support units are extended.

5. The machine of claim 1, wherein the controller is further configured to generate a control signal to adjust the extension of the two or more extendable support units to control an elevation of the frame.

6. The machine of claim 5, wherein to control the elevation of the frame is to reduce a displacement of the frame from an initial position when a topology of the surface changes.

7. The machine of claim 1, wherein the distance sensor is coupled to an area of the frame proximate to a posterior end of the frame.

8. The machine of claim 1, wherein the orientation sensor is coupled to the frame proximate to the center of mass of the frame.

9. The machine of claim 1, wherein the orientation sensor is configured to measure a slop and pitch of the frame.

10. The machine of claim 9, wherein the orientation sensor comprises an inertial sensor.

11. The machine of claim 9, wherein the orientation sensor comprises two or more distance sensors configured to form a plane with the distance sensor on the frame, and the controller is configured to determine the orientation based on an orientation of the plane relative to the surface.

12. The machine of claim 11, wherein the two or more distance sensors are coupled to an anterior area of the frame proximate to at least two extendable support units of the two or more extendable support units, and the distance sensor is coupled to the posterior end of the frame proximate to another extendable support unit of the two or more extendable support units.

13. A method for determining an elevation of a machine relative to a surface, the method comprising:
providing a distance sensor for measuring a distance from a frame of the machine to the surface;
providing orientation sensor for measuring an orientation of the frame of the machine; and
providing a controller that is configured with computer executable code, the computer executable code executable by a processor of the controller to perform operations comprising:
monitoring an output of the distance sensor to determine a distance from the frame to the surface,
monitoring an output of the orientation sensor to determine an orientation of the frame,
determining, using distance and the orientation, a position of at least one extendable support unit coupled to the frame.

14. The method of claim 13, wherein the operations further comprise:
adjusting the elevation of the frame based on the position of the at least one extendable support unit.

15. The method of claim 14, wherein adjusting the elevation of the frame comprises:
adjusting an extension of the at least one extendable support unit based on the determined position of the at least one extendable support unit.

16. The method of claim 15, wherein adjusting the elevation of the frame comprises:
controlling a rate of adjusting the extension of the at least one extendable support unit to minimize displacement of the frame from an initial position.

17. The method of claim 14, wherein the operations further comprise:
determining a position of the one or more extendable support unit based on a location of the distance sensor and a location of the orientation sensor on the frame.

18. A non-transitory computer-readable storage medium storing a set of instructions that, when executed by at least one processor of a machine configured with a distance sensor and an orientation sensor, cause the machine to:
receive, from the distance sensor, data that is indicative of a distance from a frame of the machine to a surface;
receive, from the orientation sensor, data that is indicative of an orientation of the frame of the machine;
determine, based on the distance and the orientation, a position of one or more extendable support units coupled to the frame; and
generate a control signal to adjust an extension of the one or more extendable support units based on the position of the one or more extendable support units.

19. The non-transitory computer-readable storage medium of claim 18, wherein the instructions further cause the machine to:
determine the position of the one or more extendable support units based on a location of the distance sensor on the frame and a location of the orientation sensor on the frame.

20. The non-transitory computer-readable storage medium of claim 18, wherein the control signal is configured to adjust the extension of the one or more extendable support units based on the position of the one or more extendable support units to minimize displace of the frame due to a change in a topology of the surface.
